(19) United States
(12) Patent Application Publication
(10) Pub. No.: US 2002/0062441 A1
(43) Pub. Date: May 23, 2002

(54) Authentication apparatus for authentication to permit electronic document or payment by card using personal information of individual, verification apparatus for verifying individual at payment site, and electronic authentication system interconnecting the same

(75) Inventor: Tsukasa Ooishi, Hyogo (JP)

Correspondence Address: McDERMOTT, WILL & EMERY, 600 13th Street, N.W., Washington, DC, 20005-3096, US

(73) Assignee: MITSUBISHI DENKI KABUSHIKI KAISHA

(21) Appl. No.: 09/824,219

(22) Filed: Apr. 3, 2001

(30) Foreign Application Priority Data
Nov. 22, 2000 (JP) 2000-355565(P)

(51) Int. Cl. H04L 9/00

(52) U.S. Cl. 713/176; 705/67

(57) ABSTRACT

A logic operation portion performs an operation on an original sign using personal information obtained by digitizing information associated with a physical feature of an individual for generating an encrypted electronic signature. An electronic signature adding portion adds the electronic signature to an electronic document for distribution. Thus, it becomes difficult to identify an individual and criminal use due to forgery of the electronic signature is prevented. As a result, security of privacy and property of the individual in the market is assured.

### BACKGROUND OF THE INVENTION

1. Field of the Invention

The present invention relates to a technique for preventing forgery or criminal use of electronic documents, credit cards, etc. More particularly, the present invention relates to an authentication apparatus for authentication to permit payment by an electronic signature or a card, a verification apparatus for verifying an individual at a payment site, and an electronic authentication system interconnecting the same.

2. Description of the Background Art

Conventionally, cards, including credit cards, have been widely used to make payments when a customer purchases goods at a store. For a card transaction, an authentication must be made to identify a card holder. To that end, a handwritten signature, private identification number or the like is used for authentication.

In recent years, due to widespread use of the Internet, electronic commerce transactions have been on the increase where a customer purchases goods at his or her own terminal. Since the user can purchase goods at the terminal, there is no need to go to stores for shopping, whereby a greater level of convenience is achieved.

In addition, a technique has been developed for detecting forgery of documents by determining validity of electronic signatures distributed with the electronic documents.

However, in such a card transaction, forgery of private identification numbers or signatures may occur, leading to criminal use of cards, if a card is lost or stolen. In this case, even if the criminal use of the card is detected by subsequent authentication, a card holder and a credit card company must go through a laborious process or enormous damages may be caused.

Further, in an electronic commerce transaction, when a user actually purchases good through the Internet, the credit card number or private identification number of the user may leak for criminal use.

Moreover, in the technique for adding electronic signatures to electronic documents, inconsistent management of the electronic signatures may allow forgery of electronic signatures for criminal use as well as undue infringement of privacy or property of an individual.

### SUMMARY OF THE INVENTION

An object of the present invention is to provide an authentication apparatus capable of preventing forgery of electronic signatures for criminal use.

Another object of the present invention is to provide an authentication apparatus capable of preventing forgery of information such as a private identification number or signature used for identifying a holder of a card, e.g., a credit card.

Still another object of the present invention is to provide a verification apparatus capable of properly verifying an individual at the time of payment, for example with a credit card.

Still another object of the present invention is to provide an authentication apparatus capable of preventing leakage and criminal use of security information such as a credit card number or private identification number of a user when he or she purchases goods through a data communication network such as the Internet.

According to one aspect of the present invention, an authentication apparatus collects electronic documents distributed with electronic signatures for authentication. The authentication apparatus includes: an electronic signature generating portion generating an encrypted electronic signature by performing a first operation using personal information obtained by digitizing information relevant to a physical feature of an individual and adding the electronic signature to the electronic document; and an identity authenticating portion extracting the electronic signature of the electronic document and authenticating the individual by performing a second operation for decryption.

The electronic signature generating portion generates the encrypted electronic signature by performing the first operation using personal information obtained by digitizing information relevant to the physical feature of the individual, which makes it difficult to identify he or she, whereby forgery and criminal use of the electronic signature can be prevented. Thus, adequate security of privacy and property of the individual is provided in the market.

According to another aspect of the present invention, an authentication apparatus authenticates personal identification at the time of card payment. The authentication apparatus includes: an identification information generating portion for generating encrypted identification information by performing a logic operation on first information using personal information of the individual; and an authenticating portion for authenticate personal identification by comparing the identification information which has been pre-recorded in the card with identification information generated by the identification information generating portion.

The authenticating portion compares the identification information that has been pre-recorded in the card with that generated by the identification information generating portion for authentication, so that the individual can be easily authenticated. If information for identifying the individual is not added to the card, the card holder cannot be easily identified, whereby the risk of criminal use decreases.

According to still another aspect of the present invention, a verification apparatus verifies identity of the individual by a handwritten signature at the time of card payment. The verification apparatus includes: a logic operation portion for performing a logic operation on identification information recorded in the card using a cipher key for generating first sign information; and an identity determining portion for identifying the individual by comparing the first sign information generated by the logic operation portion with second sign information obtained by digitizing the handwritten signature.

The identity determining portion identifies the individual by comparing the first sign information generated by the logic operation portion with the second sign information obtained by digitizing the handwritten signature, so that the individual can be easily identified.

According to still another aspect of the present invention, an electronic authentication system includes a verification apparatus for verifying an individual by a handwritten signature at the time of card payment, and an authentication apparatus for determining validity of payment, which are interconnected. The authentication apparatus includes: a personal bit information generating portion for encrypting personal information on the individual for generating personal bit information; a first logic operation portion performing a logic operation using the personal bit information generated by the personal bit information generating portion on the first information for generating identification information; a cipher key generating portion performing a logic operation using the identification information generated by the first logic operation portion on the first sign information obtained by digitizing the handwritten signature for generating a cipher key; a private identification number extracting portion extracting a private identification number from the information transmitted from the verification apparatus; a logic inverse operation portion for performing a logic inverse operation using the personal bit information generated by the personal bit information generating portion on the private identification number extracted by the private identification number extracting portion for generating second information; and a comparing portion comparing the first information with the second information generated by the logic inverse operation portion for determining validity of payment. The verification apparatus includes: a second logic operation portion performing a logic operation using a cipher key generated by the cipher key generating portion on the identification information recorded in the card for generating second sign information; and an identity determining portion comparing the second sign information generated by the second logic operation portion with third sign information obtained by digitizing the handwritten signature for identifying the individual.

The identity determining portion compares the second sign information generated by the second logic operation portion with the third sign information obtained by digitizing the handwritten signature for identifying the individual, so that the individual can be easily identified. In addition, the comparing portion compares the first information with the second information generated by the logic inverse operation portion for determining validity of payment, whereby any undue payment, e.g., due to forgery of the card, can be detected. Further, if communication between the verification apparatus and the authentication apparatus is wireless communication or performed over a network, validity determination of payment is made in real time.

According to still another aspect of the present invention, an authentication apparatus authenticates personal identification when a payment request is transmitted from an external portion. The authentication apparatus includes: a private identification number generating portion performing a logic inverse operation using a first number which changes over time on personal information of an individual for generating an encrypted private identification number; and an identifying portion performing a logic operation using the private identification number generated by the private identification number generating portion for identifying the individual based on the logic operation result.

The private identification number generating portion performs the logic inverse operation using the first number which changes over time on the personal information of the individual for generating the encrypted private identification number. Thus, even if the private identification number is leaked for criminal use, such event is detected in identifying the individual since the private identification number has already been changed at that point of time. Accordingly, the individual can be properly identified.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a schematic structure of an authentication apparatus according to a first embodiment of the present invention.

FIGS. 2 to 6 are diagrams respectively shown in conjunction with functional structures of authentication apparatuses according to first to fifth embodiments of the present invention.

### DESCRIPTION OF THE PREFERRED EMBODIMENTS

### First Embodiment

An electronic authentication system according to the first embodiment of the present invention is adapted to distribute an electronic document such as a decision document, direct mail, etc., along with a signature of an individual added thereto, and then collect the electronic document for determining its validity. In the electronic authentication system, an authentication apparatus located in an advertising agent, trading company or the like adds the electronic signature and verifies the electronic document.

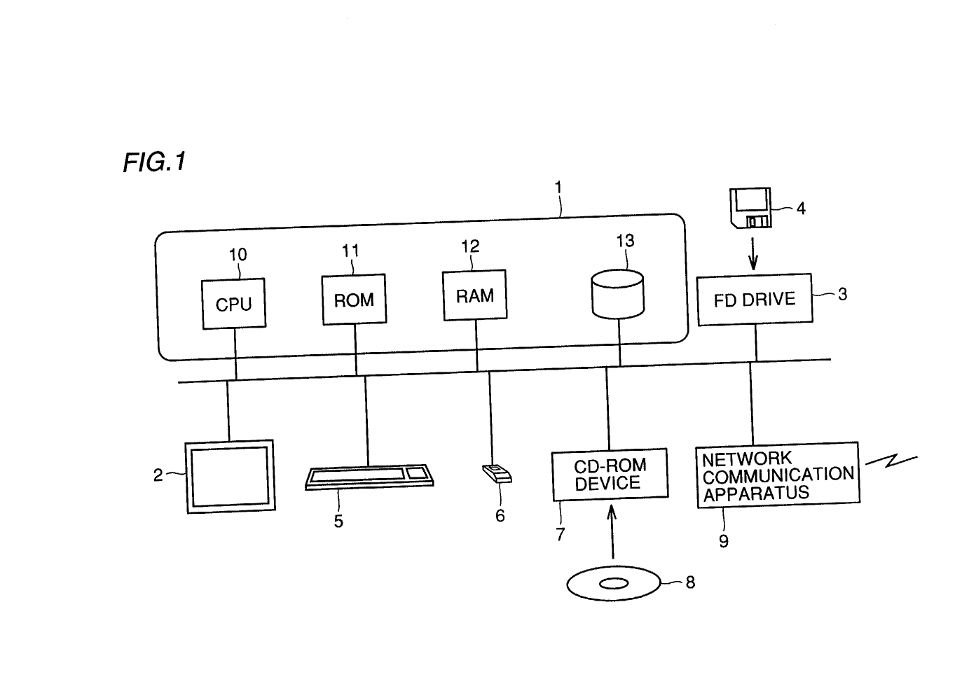

FIG. 1 is a diagram showing a schematic structure of an authentication apparatus of the present embodiment. The authentication apparatus includes a computer 1, a graphic display 2, an FD (Flexible Disk) drive 3 with an FD4 inserted, a keyboard 5, a mouse 6, a CD-ROM (Compact Disk-Read Only Memory) with a CD-ROM 8 mounted, and a network communication apparatus 9. An authentication program is supplied from a storage medium such as FD4 or CD-ROM 8. The authentication program is executed by computer 1 for addition of an electronic signature and authentication of an electronic document. Alternatively, the authentication program may be supplied to computer 1 over a communication line from another computer.

Computer 1 further includes a CPU (Central Processing Unit) 10, an ROM (Read Only Memory) 11, an RAM (Random Access Memory) 12, and a hard disk 13. CPU 10 inputs/outputs data with respect to graphic display 2, magnetic tape device 3, keyboard 5, mouse 6, CD-ROM device 7, network communication apparatus 9, ROM 11, RAM 12, hard disk 13 and the like. The authentication program recorded in FD4 or CD-ROM 8 is temporarily stored in hard disk 13 through FD drive 3 or CD-ROM device 7 from CPU 10. CPU 10 adds the electronic signature and verifies the electronic document by appropriately loading to and executing at RAM 12 the authentication program from hard disk 13.

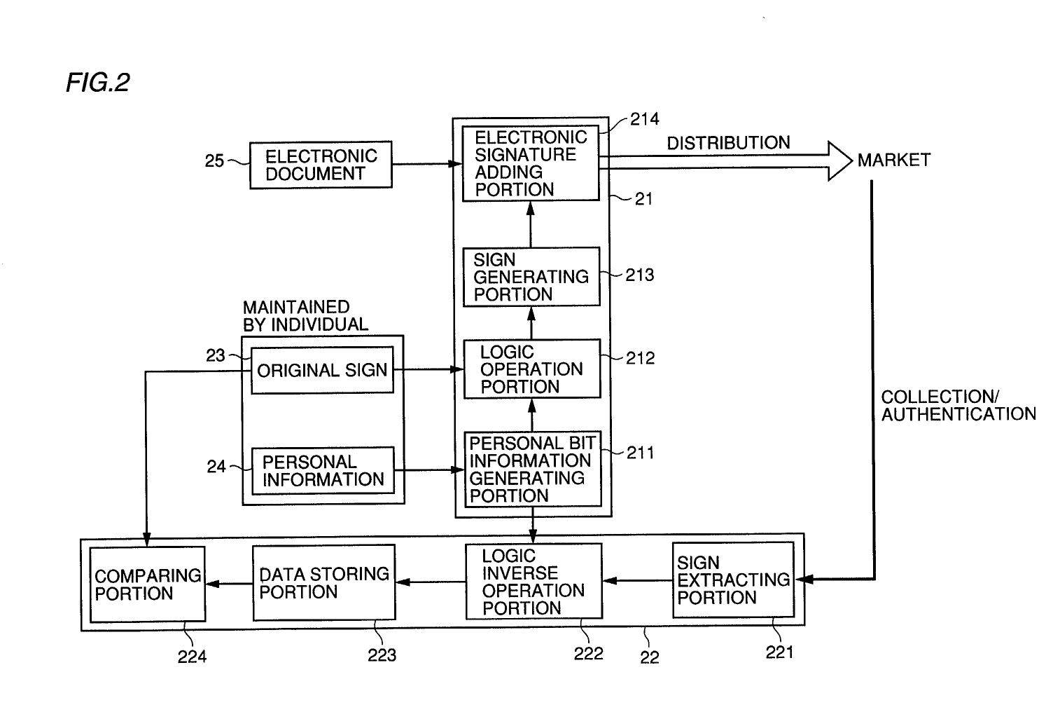

FIG. 2 is a block diagram showing a functional structure of an authentication apparatus of the present embodiment. The authentication apparatus includes an electronic signature generating portion 21 and a document authenticating portion 22. Electronic signature generating portion 21 includes: a personal bit information generating portion 211 converting personal information 24 of an individual who signs the electronic document to a numeric array for encryption; a logic operation portion 212 performing a logic operation using original sign 23 of the individual and information which has been subjected to encryption by personal bit information generating portion 211 (hereinafter referred to as personal bit information); a sign generating portion 213 outputting the information which has been subjected to the logic operation by logic operation portion 211 as a sign of the individual; and an electronic signature adding portion 214 adding the sign output from sign generating portion 213 to electronic document 25.

Document authenticating portion 22 includes: a sign extracting portion 221 collecting an electronic document which has been distributed to the market with an electronic signature added thereto for extracting a sign of the individual; a logic inverse operation portion 222 for performing a logic inverse operation using personal bit information output from personal bit information generating portion 211 on the sign extracted by sign extracting portion 221; a portion for storing data which has been subjected to the inverse operation by logic inverse operation portion 222 (hereinafter simply referred to as a data storing portion 223); and a comparing portion 224 comparing data stored in data storing portion 223 and original sign 23 held by the individual for authenticating the electronic signature.

For personal information 24, specific information associated with a physical feature of the individual, e.g., fingerprints, retinal pattern, DNA (DeoxyriboNucleic Acid), or the like is used. Personal bit information generating portion 211 has a mechanism for obtaining personal information 24. Personal bit information generating portion 211 optically reads fingerprints of the individual and then changes the information to an electronic form for converting personal information 24 to a numeric array, for example. Then, personal bit information generating portion 211 encrypts the personal information which has been converted to the numeric array with use of a predetermined cipher key for generating personal bit information and outputting it to logic operation portion 212 and logic inverse operation portion 222. The personal bit information is used as an encryption key.

Logic operation portion 212 performs a logic operation on original sign 23 from the individual using personal bit information output from personal bit information generating portion 211. Original sign 23 does not mean a handwritten signature of the individual, but data predetermined by the individual and held as a confidential matter, including a private identification number or the like. Sign generating portion 213 outputs data which has been subjected to the logic operation output from logic operation portion 212 as a sign to electronic signature adding portion 214.

Electronic signature adding portion 214 adds the sign output from sign generating portion 213 to electronic document 25. Then, the electronic document with the sign added is distributed to the market for use. Note that the sign from sign generating portion 213 may be returned to the individual, who adds the sign to the electronic document for distribution to the market.

Once the distributed electronic document is collected, the electronic signature is authenticated to obtain confirmation that the electronic document is not a forgery. Sign extracting portion 221 extracts the sign from the collected electronic document. Since the sign is at a predetermined portion, sign extracting portion 221 extracts the sign by reading data from that portion.

Logic inverse operation portion 222 performs a logic inverse operation using personal bit information on the sign extracted by sign extracting portion 221 for generating an original sign and storing it in data storing portion 223. Thereafter, comparing portion 224 compares original sign 23 held by the individual with that stored in data storing portion 223 for authentication of the electronic signature. As a result, a determination can be made as to if the signature of the electronic document has been made by the identical person.

As described above, in the electronic authentication system of the present embodiment, the specific information of the individual is converted to the numeric array to generate a cipher key, which is then used for encryption of original sign 23. Conventionally, the individual may be easily identified, leading to forgery of a signature. However, the electronic authentication system of the present embodiment makes it difficult to identify the individual, whereby forgery of the signature can be prevented. This provides security of privacy and property of an individual in the market.

### Second Embodiment

An electronic authentication system of the present embodiment determines personal identification when a customer uses a card, e.g., a credit card, for purchase of goods at a store and authenticates the individual in order to determines validity of payment some other day. In the electronic authentication system, an authentication apparatus, which is mainly located in a store or the like where payment by the card is made, determines personal identification at the payment site and authenticate the individual in order to determine validity of payment some other day. Note that the card does not have any information used for identifying personal identification, including a handwritten signature or picture of face, which makes it difficult to identify the card holder. Thus, the card holder cannot be identified if the card is lost or stolen, whereby the risk of criminal use decreases. In addition, since the information generated from the personal bit information is recorded in the card as will later be described, forgery of the card is extremely difficult.

The authentication apparatus of the present embodiment has the same structure as that of the first embodiment shown in FIG. 1. Therefore, the overlapping portions of the structure and function will not be described in detail.

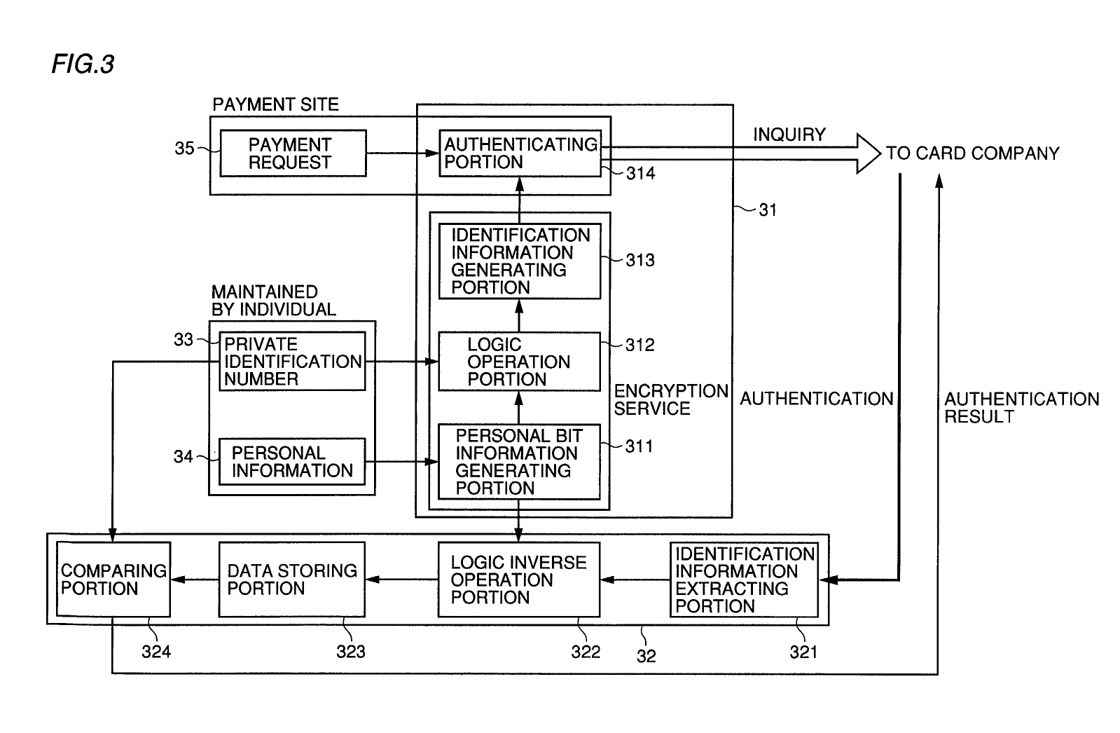

FIG. 3 is a block diagram showing a functional structure of the authentication apparatus of the present embodiment. The authentication apparatus includes: an individual authenticating portion at the time of payment 31 and a subsequent individual authenticating portion 32. Individual authenticating portion at the time of payment 31 includes a personal bit information generating portion 311 converting personal information 34 of the card holder to a numeric array for encryption; a logic operation portion 312 performing a logic operation using personal bit information generated by personal bit information generating portion 311; an identification information generating portion 313 outputting information which has been subjected to a logic operation by logic operation portion 312 as information used for identification of identical person (identification information); and an authenticating portion 314 comparing the identification information output from identification information generating portion 313 with that stored in the credit card for authentication at the time of payment and transmitting the information including the identification information read from the card to a credit card company.

Subsequent individual authenticating portion 32 includes: an identification information extracting portion 321 receiving an authentication request from the credit card company and extracting the identification information from the information transmitted from the credit card company; a logic inverse operation portion 322 performing a logic inverse operation using personal bit information output from personal bit information generating portion 311 on the identification information extracted by identification information extracting portion 321; data storing portion 323 storing data which has been subjected to the logic inverse operation by logic inverse operation portion 322; and a comparing portion 324 comparing data stored in data storing portion 323 with a private identification number 33 held by identical person for authentication of personal identification.

As in the first embodiment, specific information associated with a physical feature of the individual is used as personal information 34. Personal bit information generating portion 311 uses a predetermined cipher key to encrypt the personal information which has been converted to the numeric array for generating personal bit information and outputting it to logic operation portion 312 and logic inverse operation portion 322. The personal bit information is used as a cipher key.

Logic operation portion 312 performs a logic operation using personal bit information output from personal bit information generating portion 311 on the private identification number from the identical person. Then, identification information generating portion 313 outputs data which has been subjected to a logic operation output from logic operation portion 312 as identification information. The identification information is prerecorded in the card that the identical person possesses.

Authenticating portion 314 has a mechanism for reading information recorded in the card which is presented by a customer at the time of payment, e.g., a card reader. Authenticating portion 314 compares the identification information of the information read from the card with the identification information output from identification information generating portion 313 for authentication of the card. At the time, a purchaser of goods or the like presents information showing an identity of that person, e.g., a name, at the payment site. Authenticating portion 314 selects the identification information based on the presented name or the like related to that individual for authentication.

After the authentication is completed at the payment site and a payment is made with a credit card, authenticating portion 314 transmits the identification information read from the card, information identifying goods for which a payment has been made and the like to a credit card company for inquiry.

If an authentication request is subsequently made by the credit card company, an authentication is made to determine the validity of payment. Identification information extracting portion 321 extracts the identification information from the information transmitted from the credit card company for outputting it to logic inverse operation portion 322. Logic inverse operation portion 322 performs a logic inverse operation using personal bit information on the identification information extracted by identification information extracting portion 321 and generates a private identification number for storage in data storing portion 323. Then, comparing portion 324 compares private identification number 33 held by the identical person with that stored in data storing portion 323 for determination of validity of payment, and the determination result is transmitted to the credit card company. As a result, determination is made whether the card holder has made a payment with the credit card.

In the present embodiment, the authentication is made by storing the identification information in the card. However, a portable information terminal may hold the identification information, which is connected to the authentication apparatus, for determining validity of payment. Further, in the present embodiment, the authentication apparatus is located in a company or the like other than the credit card company. However, if the authentication apparatus is located in the credit card company, identification information extracting portion 321 directly extracts identification information from the information read from the card. In this case, leakage risk of the identification information further decreases, whereby the reliability of authentication increases.

As described above, in the electronic authentication system of the present embodiment, the specific information of the individual is converted to the numeric array to generate a cipher key, which is then used to encrypt private identification number 33 for authentication. Accordingly, if the card is lost or stolen, criminal use of the card can be prevented since identification of the individual is difficult.

### Third Embodiment

An electronic authentication system of a third embodiment of the present invention determines personal identification when a customer purchases goods at a store with a card and authenticates the individual for determining validity of payment in real time. In the electronic authentication system, a terminal device located in a store or the like where a card payment is made reads identification information stored in the card, which is then transmitted to an authentication apparatus located in a credit card company for validity determination of payment at the payment site in real time. Note that, as in the second embodiment, the card does not have any information for identifying the individual, including a handwritten signature or picture. Thus, the card holder cannot be easily identified. Accordingly, even if the card is lost or stolen, risk of criminal use is low because the card holder cannot be identified. In addition, as will later be described, since the card has information generated from personal bit information, forgery of the card is extremely difficult.

The authentication apparatus of the present embodiment has the same structure as that of the first embodiment shown in FIG. 1. Thus, overlapping portions of the structure and function will not be described in detail.

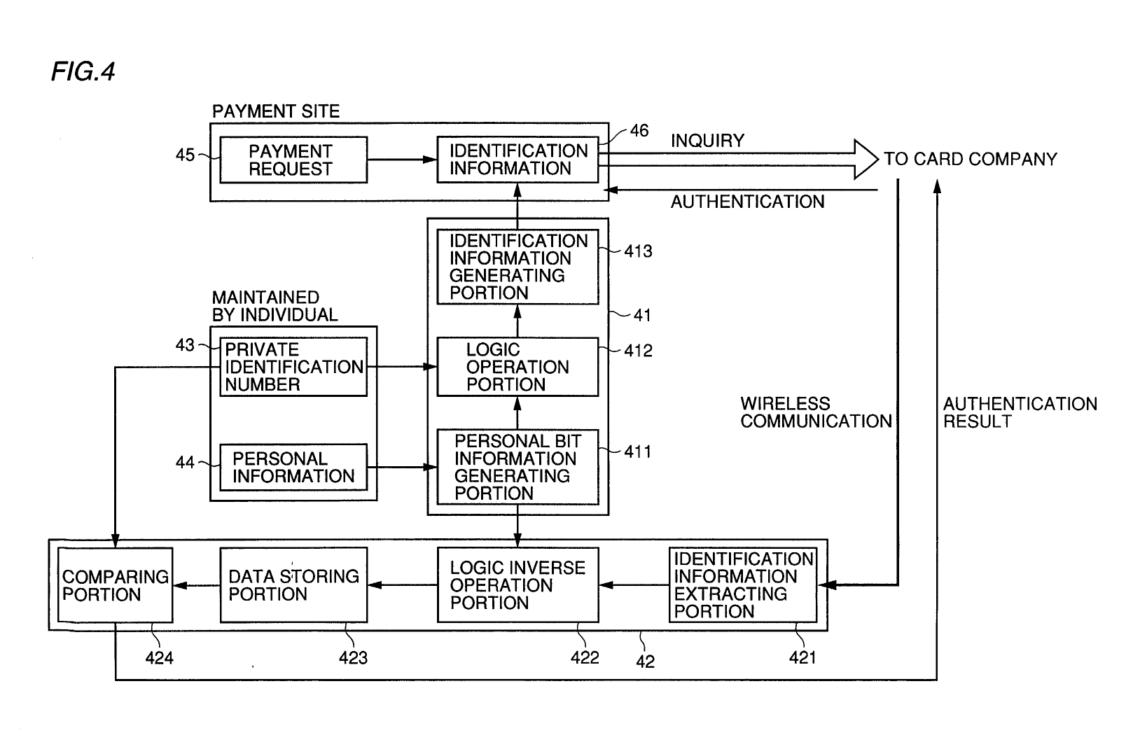

FIG. 4 is a block diagram showing a functional structure of the authentication apparatus of the present embodiment. The authentication apparatus includes an identification information producing portion 41 and an individual authenticating portion 42. Identification information producing portion 41 includes: a personal bit information generating portion 411 converting personal information 44 of a card holder to a numeric array for encryption; a logic operation portion 412 using personal bit information generated by personal bit information generating portion 411 for a logic operation; and an identification information generating portion 413 outputting the information which has been subjected to the logic operation by logic operation portion 412 as identification information of the individual.

Individual authenticating portion 42 includes: an identification information extracting portion 421 receiving an authentication request from the credit card company for extracting identification information from information transmitted therefrom; a logic inverse operation portion 422 using the personal bit information output from personal bit information generating portion 411 on the identification information extracted by identification information extracting portion 421 for a logic inverse operation; a data storing portion 423 storing data which has been subjected to the logic inverse operation by logic inverse operation portion 422; and a comparing portion 424 comparing the data stored in data storing portion 423 with a private identification number 43 held by the identical person for authentication of personal identification.

As in the first embodiment, specific information associated with a physical feature of the individual is used as personal information 44. Personal bit information generating portion 411 encrypts the personal information which has been converted to the numeric array with use of a predetermined cipher key for outputting them to logic operation portion 412 and logic inverse operation portion 422. The personal bit information is used as a cipher key.

Logic operation portion 412 performs a logic operation using personal bit information output from personal bit information generating portion 411 on the private identification number obtained from the individual. Identification information generating portion 413 outputs data which as been subjected to the logic operation output from logic operation portion 412 as identification information. The identification information is pre-recorded in the card that the individual possesses.

The terminal device located in a store or the like has a mechanism for reading the card, e.g., a card reader, and reads information including the identification information stored in the card that the purchaser of goods presents for transmitting information including the identification information to a credit card company by means of a network, wireless communication or the like. It is noted that the general structure of the terminal device is the same as that of the first embodiment shown in FIG. 1 except that the card reader is connected, and therefore detailed description thereof will not be given.

Upon receipt of information from the terminal device, the credit card company transmits the information to the authentication apparatus over a network or by wireless communication. Identification information extracting portion 421 extracts the identification information of the information transmitted from the card company for transmitting it to logic inverse operation portion 422. Logic inverse operation portion 422 performs a logic inverse operation on the identification information extracted from identification information extracting portion 421 using the personal bit information for generating a private identification number and storing it in data storing portion 423.

Comparing portion 424 compares private identification number 43 presented by the individual with that stored in data storing portion 423 for determining validity of payment, and the determination result is transmitted to the card company. The card company transmits the determination result to the terminal device located at the payment site. As a result, a determination can be made as to if card payment has been made by a card holder.

In the present embodiment, the identification information is stored in the card for authentication. However, a portable information terminal may hold identification information, which portable information terminal being connected to the terminal device, for determining validity of payment. Further, the authentication apparatus has been described as being located in a company other than a credit card company. However, if the authentication apparatus is located in the credit company, identification information extracting portion 421 directly extracts the identification information from the information read from the card. In this case, leakage risk of the identification information decreases, whereby reliability of authentication increases.

As described above, in the electronic authentication system of the present embodiment, specific information of the individual is converted to the numeric array for generation of a cipher key, which is then used to encrypt private identification number 43 for authentication. Accordingly, even if the card is lost or stolen, criminal use of the card can be prevented since identification of the individual is difficult. In addition, the identification information read at the payment site is transmitted to the authentication apparatus over a network or by wireless communication, and the authentication result is also transmitted to the payment site in real time, so that validity of payment can be determined at the payment site.

### Fourth Embodiment

An electronic authentication system of the fourth embodiment of the present invention determines personal identification when a customer purchases goods at a store with a card, e.g., a credit card, and authenticates the individual in order to determine validity of payment some other day. In the electronic authentication system, a verification apparatus located in a store or the like where a card payment is made compares a sign generated from information recorded in the card with a handwritten signature for authentication of personal identification. Further, the authentication apparatus located in a credit card company or the like determines validity of subsequent payment. It is noted that the card does not have any information, including a handwritten signature or picture of face, which may be used for identifying the card holder. Thus, the card holder cannot be easily identified. Accordingly, even if the card is lost or stolen, the card holder cannot be identified. Thus, risk of criminal use decreases. Further, as will later be described, since the information generated from the personal bit information is recorded in the card, forgery of the card is extremely difficult.

The authentication apparatus of the present embodiment is generally the same as that of the first embodiment shown in FIG. 1. The verification apparatus of the present embodiment is the same as that of the first embodiment of FIG. 1 except that it further includes a mechanism for optically reading a handwritten signature to convert it to an electronic form as well as a mechanism, e.g., a card reader, which reads out information recorded in the card. Accordingly, a detailed description of overlapping portions of the structure and function will not be given here.

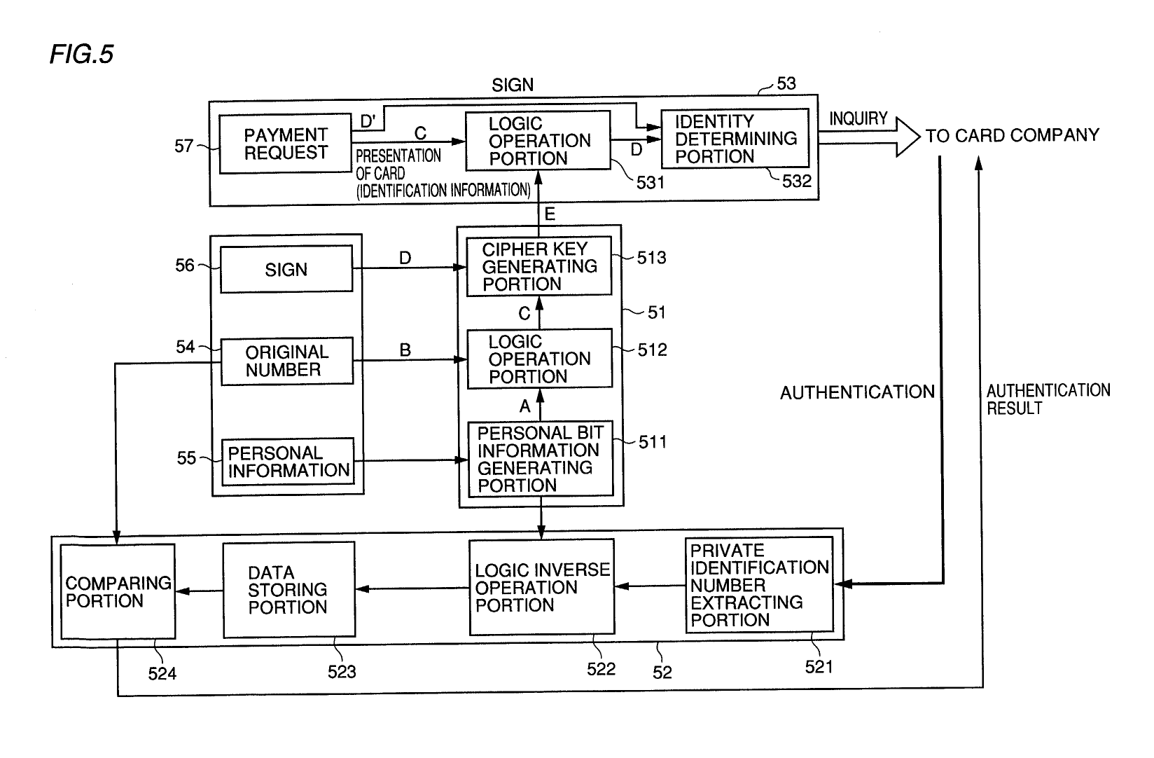

FIG. 5 is a block diagram showing a functional structure of the verification apparatus and authentication apparatus of the present embodiment. Verification apparatus 53 includes: a logic operation portion 531 performing a logic operation on the information read from the card with use of a cipher key; and an identity determining portion 532 comparing information generated by converting the handwritten signature to the electronic form with that which has been subjected to the logic operation by logic operation portion 531 for authentication of personal identification.

The authentication apparatus includes a cipher key producing portion 51 and subsequent individual authenticating portion 52. Cipher key producing portion 51 includes: a personal bit information generating portion 511 converting personal information 55 of a card holder to a numeric array for encryption; a logic operation portion 512 performing a logic operation on an original number 54 held by the identical person using personal bit information generated by personal bit information generating portion 511; and a cipher key generating portion 513 performing a logic operation using information which has been subjected to the logic operation by logic operation portion 512 for generating a cipher key.

Subsequent individual authenticating portion 52 includes a private identification number extracting portion 521 receiving an authentication request from a card company for extracting a private identification number from information transmitted from the card company; a logic inverse operation portion 522 performing a logic inverse operation using personal bit information output from personal bit information generating portion 511 on the private identification number extracted by private identification number extracting portion 521; a data storing portion 523 storing data which has been subjected to the logic inverse operation by logic inverse operation portion 522; and a comparing portion 524 comparing data stored in data storing portion 523 with original number 54 held by the card holder for authentication of personal identification.

As in the first embodiment, specific information associated with a physical feature of the card holder is used as personal information 55. Personal bit information generating portion 511 encrypts personal information which has been converted to the numeric array with use of a predetermined cipher key for generating personal bit information and outputting them to logic operation portion 512 and logic inverse operation portion 522. The personal bit information is used as an encryption key.

Logic operation portion 512 performs a logic operation on original number (B) from the holder with use of personal bit information (A) output from personal bit information generating portion 511. Then, data (C=A×B) which has been subjected to the logic operation output from logic operation portion 512 is output to cipher key generating portion 513 as a private identification number. The private identification number is prerecorded in the card that the identical person possesses. Assume that the logic operation for encryption only involves multiplication (x) for simplicity of description.

Cipher key generating portion 513 further performs a logic inverse operation using private identification number (C) output from logic operation portion 512 on a handwritten signature (D) of the identical person. Then, cipher key generating portion 513 transmits a logic inverse operation result (E=D÷C) to a verification apparatus located at the payment site as a cipher key.

The verification apparatus located at the payment site reads private identification number (C) from the card that a purchaser of goods or the like presents and optically reads a handwritten signature of the purchaser of goods to convert it to electronic information (D′). Logic operation portion 531 performs a logic operation on read private identification number (C) using a cipher key (E) output from cipher key generating portion 513. Logic operation portion 531 outputs the logic operation result (D=C×E) to identity determining portion 532.

Identify determining portion 532 compares logic operation result (D) output from logic operation portion 531 with information (D′), i.e., the electronic data of the handwritten signature, for identifying the identical person. After identification of the identical person at the payment site and payment with a credit card, the verification apparatus transmits to a credit card company a private identification number and information for identifying goods for which the payment has been made for inquiry.

If the credit card company subsequently makes request for authentication, the authentication is performed in order to determine validity of payment. Private identification number extracting portion 521 extracts the private identification number from information transmitted from the credit card company and outputs it to logic inverse operation portion 522. Logic inverse operation portion 522 performs a logic inverse operation using personal bit information on the private identification number extracted by private identification number extracting portion 521 and generates an original number for storage in data storing portion 523. Comparing portion 524 compares original number 54 that the identical person possesses with that stored in data storing portion 523 for determining validity of payment, and the determination result is transmitted to the credit card company. As a result, a determination can be made whether or not the card holder has made a payment with a credit card.

In the present embodiment, the identification information is stored in the card for authentication. However, a portable information device may hold identification information, which is connected to the verification apparatus, for determination of validity of payment. In addition, in the present embodiment, the authentication apparatus is located in a company other than a credit card company or the like. If the authentication apparatus is located in the credit card company, private identification number extracting portion 521 directly extracts identification information from information read from the card. In this case, leakage risk of the identification information further decreases, whereby reliability of authentication can be enhanced.

As described above, in the electronic authentication system of the present embodiment, specific information of the individual is converted to the numeric array for generation of a cipher key, which is then used to encrypt original number 54 for generation of a private identification number. Further, with use of the private identification number, a handwritten signature is encrypted for authentication. Accordingly, even if the card is lost or stolen, criminal use of the card can be prevented since identification of the individual is difficult. In addition, the handwritten signature of a purchaser of goods or the like and a sign generated by an operation are compared for authentication of personal identification, so that the individual can be properly identified at the payment site.

### Fifth Embodiment

An electronic authentication system of the fifth embodiment of the present invention determines personal identification when a customer purchases goods or the like through a terminal device connected to a data communication network such as the Internet, and authenticate the identical person in order to determine validity of payment subsequently or in real time. In the electronic authentication system, the verification system connected to the Internet authenticates personal identification and determines validity of payment.

The authentication apparatus of the present embodiment has a structure which is the same as that of the first embodiment shown in FIG. 1. Therefore, overlapping portions of the structure and function will not be described in detail.

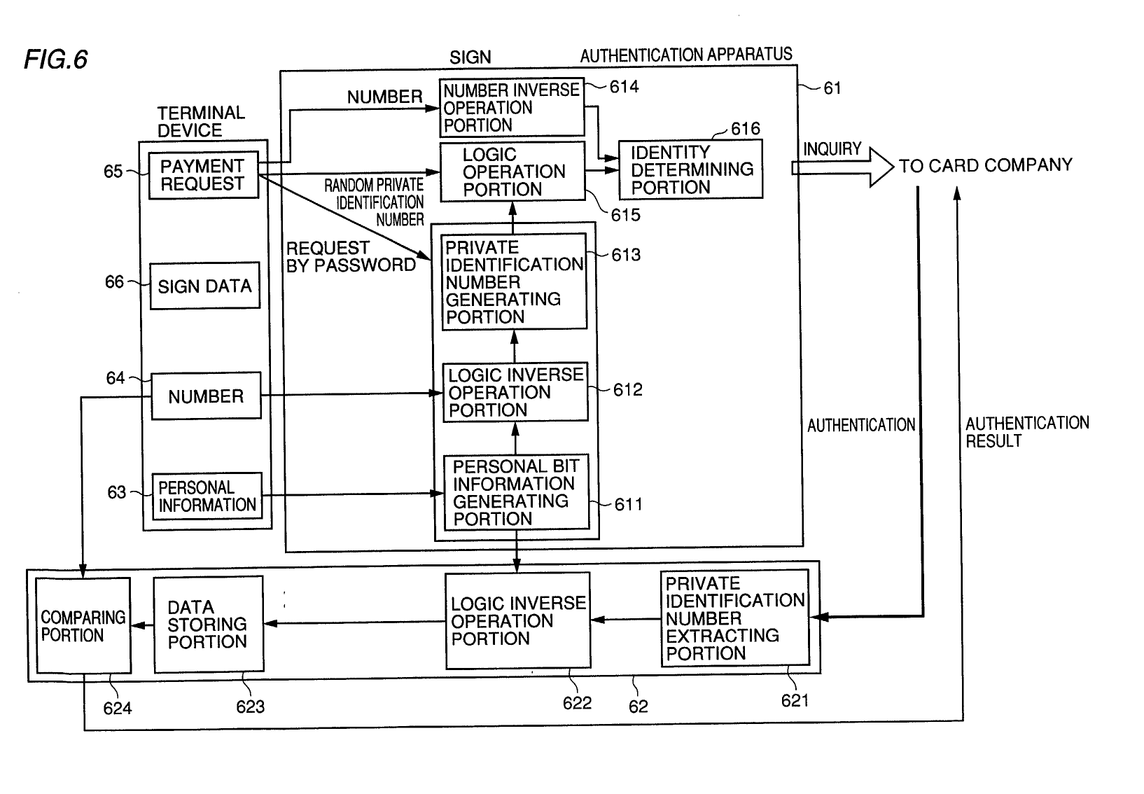

FIG. 6 is a block diagram showing a functional structure of an authentication apparatus of the present embodiment. The authentication apparatus includes an individual authenticating portion at the time of payment 61 and a subsequent individual authenticating portion 62. Individual authenticating portion at the time of payment 61 includes: a personal bit information generating portion 611 converting personal information 63 of a card holder to a numeric array; a logic inverse operation portion 612 performing a logic inverse operation using a number which changes over time on the personal bit information generated by personal bit information generating portion 611; a private identification number generating portion 613 outputting information which has been subjected to the logic inverse operation by logic inverse operation portion 612 as a private identification number; a number inverse operation portion 614 performing a logic inverse operation using a number on sign data transmitted from the terminal device; a logic operation portion 615 performing a logic operation using the private identification number output from private identification number generating portion 613 on a random private identification number transmitted from the terminal device; and an identity determining portion 616 comparing the logic operation result output from number inverse operation portion 614 with that output from logic operation portion 615 for identification of the identical person.

Subsequent individual authenticating portion 62 includes: a private identification number extracting portion 621 receiving an authentication request from a card company for extracting a private identification number from the information transmitted the card company; a logic inverse operation portion 622 performing a logic inverse operation using the private identification number extracted from private identification number extracting portion 621 on the personal bit information output from personal bit information generating portion 611; a data storing portion 623 storing data which has been subjected to a logic inverse operation by logic inverse operation portion 622; and a comparing portion 624 comparing data stored in data storing portion 623 with a number 64 held by a card holder for authentication of personal identification.

Assume that the user who purchases goods or the like through the terminal device and a service company in which the authentication apparatus is located share a predetermined original number and password, and the original number and password are preliminary registered in the terminal device and authentication apparatus. The password is used as information for identifying the user. In addition, assume that the user predetermines sign data 66, which is registered in the terminal device.

The authentication apparatus and terminal device have mechanisms receiving radio waves with a standard time superimposed, which standard time is used for encryption of information. For simplicity of description, the standard time is herein referred to as a time cipher which is multiplied by prescribed information for encryption of prescribed information. Accordingly, the numbers generated by the authentication apparatus and the terminal device change over time in synchronization with each other, so that they always have the same number. The number changing over time is represented by the following equation.

Number=original number/time cipher (1)

As in the first embodiment, specific information associated with a physical feature of the individual is used as personal information 63. Personal bit information generating portion 611 converts personal information 63 to a numeric array for generating personal bit information and outputting them to logic inverse operation portions 612 and 622. The personal bit information is used as an encryption key.

Logic inverse operation portion 612 performs a logic inverse operation using the registered original number on the personal bit information output from personal bit information generating portion 611. Then, private identification number generating portion 613 performs a logic operation on the time cipher with respect to data which has been subjected to the logic inverse operation output from logic inverse operation 612 for generating a private identification number and outputting it to logic operation portion 615. Accordingly, the private identification number is represented by the following equation.

Private identification number =personal bit information/number=personal bit information×time cipher/original number (2)

On the other hand, at the terminal device, a random private identification number is calculated using sign data 66 and personal bit information. The random private identification number is represented by the following equation.

Random private identification number=sign data/personal bit information (3)

When a payment request 65 is made as the user purchases goods or the like, sign data 66, number 64, a random private identification number and a password are transmitted from the terminal device to the authentication apparatus. Number inverse operation portion 614 performs a logic inverse operation on sign data 66 using number 64. Logic operation portion 615 performs a logic operation on the random private identification number using personal bit information selected by the password. Then, identity determining portion 616 compares the logic inverse operation result output from number inverse operation portion 614 with the logic operation result from logic operation portion 615 for authentication of personal identification. Thus, the authentication is made in accordance with the following equation.

Random private identification number×private identification number=signal data/number (4)

The above equation (4) can be rewritten as follows.

Random private identification number×private identification number=signal data×time cipher/original number (5)

It is noted that, if there is a time lag between the authentication apparatus and terminal device, the authentication apparatus receives the time of payment from the terminal device for calculating an amount of time lag therebetween, which amount is then corrected for finding a time cipher.

When payment is completed over the Internet, the authentication apparatus transmits the private identification number and information for identifying goods for which the payment has been made to the card company.

If the card company subsequently makes an authentication request, validity of payment is determined. Private identification number extracting portion 621 extracts a private identification number from information transmitted from the card company for outputting it to logic inverse operation portion 622. Logic inverse operation portion 622 performs a logic inverse operation using personal bit information on the private identification number extracted by private identification number extracting portion 621 for generating a number and storing it in data storing portion 623. Comparing portion 624 compares number 64 at the time of payment that the user has with that stored in data storing portion 623 for determining validity of payment. The determination result is transmitted to the card company. As a result, a determination can be made as to if the card holder had a transaction.

In the present embodiment, the authentication apparatus is located in a company other than a card company. If the authentication apparatus is located in the card company, private identification number extracting portion 621 directly receives a private identification number from private identification number generating portion 613. In this case, leakage risk of private identification number further decreases, whereby reliability of authentication is enhanced.

As described above, in the electronic authentication system of the present embodiment, a number is generated by the original number which have been predetermined by the card holder and the service company and time cipher, which number is used for encryption of information. Thus, leakage of private identification number or the like over the Internet can be prevented. In addition, specific information about the user is converted to the numeric array, which is used for generating the private identification number. As a result, leakage of private identification number or the like can be effectively prevented.

Although the present invention has been described and illustrated in detail, it is dearly understood that the same is by way of illustration and example only and is not to be taken by way of limitation, the spirit and scope of the present invention being limited only by the terms of the appended claims.

What is claimed is:

1. An authentication apparatus collecting a distributed electronic document with an electronic signature for authenticating said electronic document comprising:
an electronic signature generating portion using personal information obtained by digitizing information associated with a physical feature of an individual to perform a first operation on first information for generating an encrypted electronic signature and adding said encrypted electronic signature to said electronic document; and
an individual authenticating portion extracting said encrypted electronic signature added to said electronic document and performing a second operation to decrypt said encrypted electronic signature for authentication of personal identification.

2. The authentication apparatus according to claim 1, wherein said electronic signature generating portion includes
a personal bit information generating portion encrypting personal information of said individual to generate personal bit information;
a logic operation portion using the personal bit information generated by said personal bit information generating portion to perform a logic operation on said first information for encryption; and
an electronic signature adding portion adding the information encrypted by said logic operation portion as said encrypted electronic signature to said electronic document.

3. The authentication apparatus according to claim 2, wherein said individual authenticating portion includes
an extracting portion extracting said encrypted electronic signature added to said electronic document;
a logic inverse operation portion performing a logic inverse operation on said encrypted electronic signature extracted by said extracting portion using the personal bit information generated by said personal bit information generating portion for generating second information; and
a comparing portion comparing said first information with said second information generated by said logic inverse operation portion for authentication of personal identification.

4. An authentication apparatus for authenticating personal identification at a time of payment with a card comprising:
an identification information generating portion performing a logic operation on first information using personal information of an individual for generating encrypted identification information; and
an authenticating portion comparing identification information prerecorded in said card with the encrypted identification information generated by said identification information generating portion for authentication of personal identification.

5. The authentication apparatus according to claim 4, wherein said identification information generating portion includes
personal bit information generating portion encrypting personal information of said individual for generating personal bit information; and
a logic operation portion performing a logic operation on said first information using the personal bit information generated by said personal bit information generating portion for generating said identification information.

6. The authentication apparatus according to claim 5, wherein said authentication apparatus further includes
a logic inverse operation portion performing a logic inverse operation using the personal bit information generated by said personal bit information generating portion on an identification information prerecorded in said card for generating second information; and
a comparing portion comparing said first information with the second information generated by said logic inverse operation portion for authentication of personal identification.

7. The authentication apparatus according to claim 4, wherein said personal information is obtained by digitizing information associated with a physical feature of the individual.

8. A verification apparatus for verifying an individual by a handwritten signature at a time of card payment comprising:
a logic operation portion performing a logic operation on identification information recorded in said card using a cipher key for generating first sign information; and
an identity determining portion comparing first sign information generated by said logic operation portion with second sign information obtained by digitizing the handwritten signature for determining identity of the individual.

9. The verification apparatus according to claim 8, wherein said identification information is obtained by performing a logic operation on first information using personal bit information generated by encryption of personal information of the individual.

10. The verification apparatus according to claim 8, wherein said personal information is obtained by digitizing information associated with a physical feature of the individual.

11. An electronic authentication system including a verification apparatus for verifying an individual by a handwritten signature at a time of card payment and an authentication apparatus for determining validity of payment which are interconnected,
said authentication apparatus including
a personal bit information generating portion encrypting personal information of an individual for generating personal bit information;
a first logic operation portion performing a logic operation on first information using the personal bit information generated by said personal bit information generating portion for generating first identification information;
a cipher key generating portion performing a logic operation using the first identification information generated by said first logic operation portion on first sign information obtained by digitizing a handwritten signature for generating a cipher key;
a private identification number extracting portion extracting a private identification number from information transmitted from said verification apparatus;
a logic inverse operation portion performing a logic inverse operation using the personal bit information generated by said personal bit information generating portion on the private identification number extracted by said private identification number extracting portion for generating second information; and
a comparing portion comparing said first information with second information generated by said logic inverse operation portion for determining validity of payment,
said verification apparatus including
a second logic operation portion performing a logic operation using the cipher key generated by said cipher key generating portion on second identification information recorded in said card for generating second sign information; and
an identity determining portion comparing the second sign information generated by said second logic operation portion with third sign information obtained by digitizing a handwritten signature for determining identity of the individual.

12. The electronic authentication system according to claim 11, wherein said second identification information is obtained by performing a logic operation on the first information using personal bit information generated by encrypting personal information of the individual.

13. The electronic authentication system according to claim 11, wherein said personal information is obtained by digitizing information associated with a physical feature of the individual.

14. An authentication apparatus for authenticating personal identification when a payment request is made from an external portion, comprising:
a private identification number generating portion performing a logic inverse operation using a first number changing over time on personal information of an individual for generating an encrypted private identification number; and
determining portion performing a logic operation on the externally received information using the private identification number generated by said private identification number generating portion for determining identity of the individual based on said logic operation result.

15. The authentication apparatus according to claim 14, wherein said determining portion includes
a logic operation portion externally receiving a random private identification number generated by performing a logic inverse operation on sign data predetermined by the individual using personal information of the individual for performing a logic operation on said random private identification number using the private identification number generated by said private identification number generating portion;
a number inverse operation portion externally receiving sign data and a second number changing over time for performing a logic inverse operation on said sign data using said second number; and
an identification determining portion comparing the logic operation result from said logic operation portion with the logic inverse operation result from said number inverse operation portion for determining identity of the individual.

16. The authentication apparatus according to claim 15, further comprising:
a logic inverse operation portion performing a logic inverse operation on said personal information using the encrypted private identification number generated by said private identification number generating portion for generating a third number changing over time; and
a comparing portion comparing said second number with said third number generated by said logic inverse operation portion for authentication of personal identification.

17. The authentication apparatus according to claim 14, wherein said personal information is obtained by digitizing information associated with a physical feature of the individual.
